(19) United States
(12) Patent Application Publication
(10) Pub. No.: US 2008/0024674 A1
(43) Pub. Date: Jan. 31, 2008

(54) Brightness control system and method

(75) Inventor: Jeremy S. Park, Bethpage, TN (US)

Correspondence Address: NIXON & VANDERHYE, PC, 901 NORTH GLEBE ROAD, 11TH FLOOR, ARLINGTON, VA, 22203, US

(73) Assignee: TOSHIBA AMERICA CONSUMER PRODUCTS, LLC., Wayne, NJ (US)

(21) Appl. No.: 11/702,667

(22) Filed: Feb. 6, 2007

Related U.S. Application Data
(60) Provisional application No. 60/765,205, filed on Feb. 6, 2006.

(51) Int. Cl. H04N 5/57

(52) U.S. Cl. 348/687; 348/E05.073

(57) ABSTRACT

An example brightness control system includes a light sensor positioned in the overscan portion of a television display. A control circuit compares a brightness level sensed by the light sensor to a reference brightness level and adjusts the brightness of a lamp in response thereto.

### CROSS REFERENCE TO RELATED APPLICATION

This application claims the benefit of provisional application No. 60/765,205 filed Feb. 6, 2006, the contents of which are incorporated herein in their entirety.

### BACKGROUND AND SUMMARY

This application relates to, among other things, a method and apparatus for adjusting the picture brightness of a television to, for example, automatically compensate for the diminishing brightness of a lamp.

The brightness of lamps in digital light engines will diminish over a period of usage. Thus, as a viewer watches a television more and more, the brightness of the lamp will drop. FIG. 1 is an example graph of brightness versus operating time for a lamp in a conventional liquid crystal on silicon (LCOS) television. As shown in this graph, the brightness of the lamp decreases to less than half its original value after 8000 hours of use. The graph of FIG. 1 is characteristic of other high intensity discharge lamps. Because picture brightness is a function of lamp brightness, the television picture brightness will also dim over time.

One methodology for dealing with this problem is to periodically increase the picture brightness level of the television to offset the diminishing brightness of the light. However, this is inconvenient and requires a viewer to make adjustments to the television setting on a regular basis. For example, suppose a user initially inputs a brightness level setting of 10 brightness units. Over time, the lamp output decreases and the 10 brightness unit setting actually provides a dimmer picture than it did when the user originally set it. Therefore, after 6 months or so, the user may have to set the brightness level to 12 brightness units in order to be at the same actual brightness as originally. However, by adjusting the brightness in this way, the picture could become “washed out.”.

The system and method of certain embodiments described in this application monitor the brightness level of a television picture and automatically adjust it as necessary. In an illustrative, example implementation, a sensor and electronic circuit are mounted inside the television or projector and measure and store the user's preferred picture brightness. The brightness of the television or projector is adjusted if the picture brightness becomes less or more than the stored reference brightness.

The brightness is adjusted by increasing/decreasing the output of the lamp. For example, some televisions have a high and low setting for lamp output based on user preferences which may be set using menu selections via the user interface of the television. The brightness adjustment described herein may adjust lamp output between the high and low settings. Thus, picture brightness is directly controlled by lamp brightness. “High” has a higher energy usage and shorter lamp life than the low setting, but has a higher lumen output. The current or voltage supplied to the lamp could be increased to increase its output back to the original level that was originally set by the user. Alternately or in addition, picture brightness may be increased by increasing the brightness setting originally set by the user.

In one example embodiment, a light sensor is positioned in the overscan portion of the picture and a pattern is added to the overscan data. The light sensor detects the brightness of an area of the pattern that impinges thereon. When the automatic brightness adjustment feature is enabled, the brightness of the television or projector is adjusted based on a comparison of the detected brightness and the reference brightness. This may be achieved by some preprogrammed function that is based on an amount of time the lamp has been in use compared to some saved value for that time. This information could be programmed based on graphs of light output over time. A light sensor may also be included in the engine before the light hits the imager. This sensed light could be measured and constantly or periodically compared to the users settings.

Using the system and method of certain embodiments described in this application, a user can make an initial brightness setting and thereafter adjustments to the setting are made automatically to compensate for the diminishing brightness of the lamp. Thus, a user need not make periodic manual adjustments of the brightness setting.

These and other features and advantages will be better understood from a reading of the following detailed description in conjunction with the accompanying drawings.

### BRIEF DESCRIPTION OF THE DRAWINGS

FIG. 1 is an example graph of brightness versus operating time.

FIG. 2 shows an example rear-projection television to which the brightness control system and method described herein may be applied.

FIG. 3 is a block diagram showing an example arrangement in which the brightness control system and method described herein may be implemented.

FIG. 4 shows an example position for light sensor 302.

### DETAILED DESCRIPTION OF EXAMPLE EMBODIMENTS

The brightness adjustment systems and methods described herein may be applied to any type of television or projector that includes a lamp having a brightness that diminishes over time. Examples of such televisions include, but are not limited to, projection televisions and projectors that utilize the following technologies: DLP, LCD (reflective and transmissive), and LCOS. It may also be used in any new technologies for microdisplay that use a lamp as the illumination source. Measuring brightness in an overscan area as described below is generally applicable to rear projection systems. If measurements are made near the illumination source, then the brightness adjustment system described herein may be included in front projection systems.

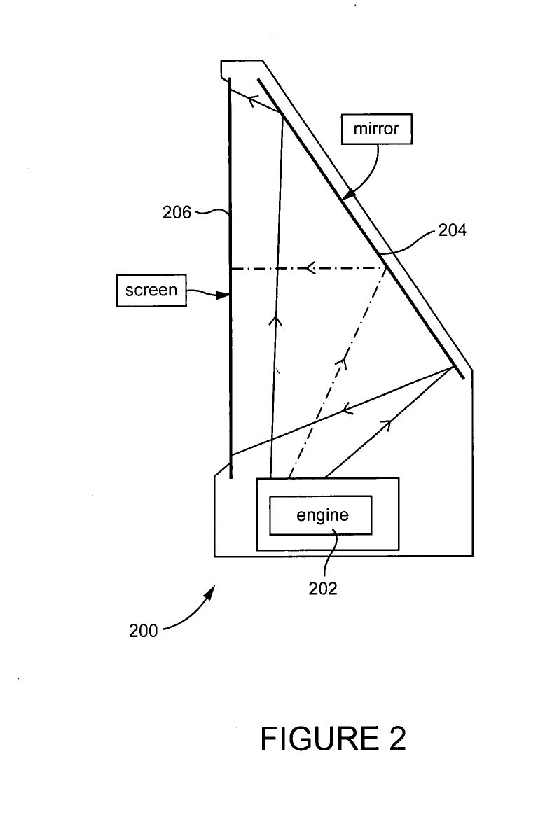

By way of example without limitation, FIG. 2 shows an illustrative rear-projection television 200 to which the brightness adjustment systems and methods described herein may be applied. Television 200 includes a light engine 202 which includes a lamp. The output of the light engine 202 is directed to a mirror 204 which reflects the output to screen 206. The light engine 202 and the imagers therein may receive display signals via a number of different input sources including, but not limited to, a cable television system, a satellite television system, a DVD player, a video game machine, a VCR, etc. as is well-known in the art. In some arrangements, the connection to a cable television system or a satellite television system may, for example, be via a set-top box. Using one or more control devices such as a remote control, front panel controls and the like, a user can select from among these input sources for viewing. Television 200 also typically includes a user interface that is activated via the control devices. This interface may include a series of displays that are displayed on screen 206 and permit the user to configure a wide variety of settings such as time, date, language of displays, brightness, contrast, color balance, audio and the like.

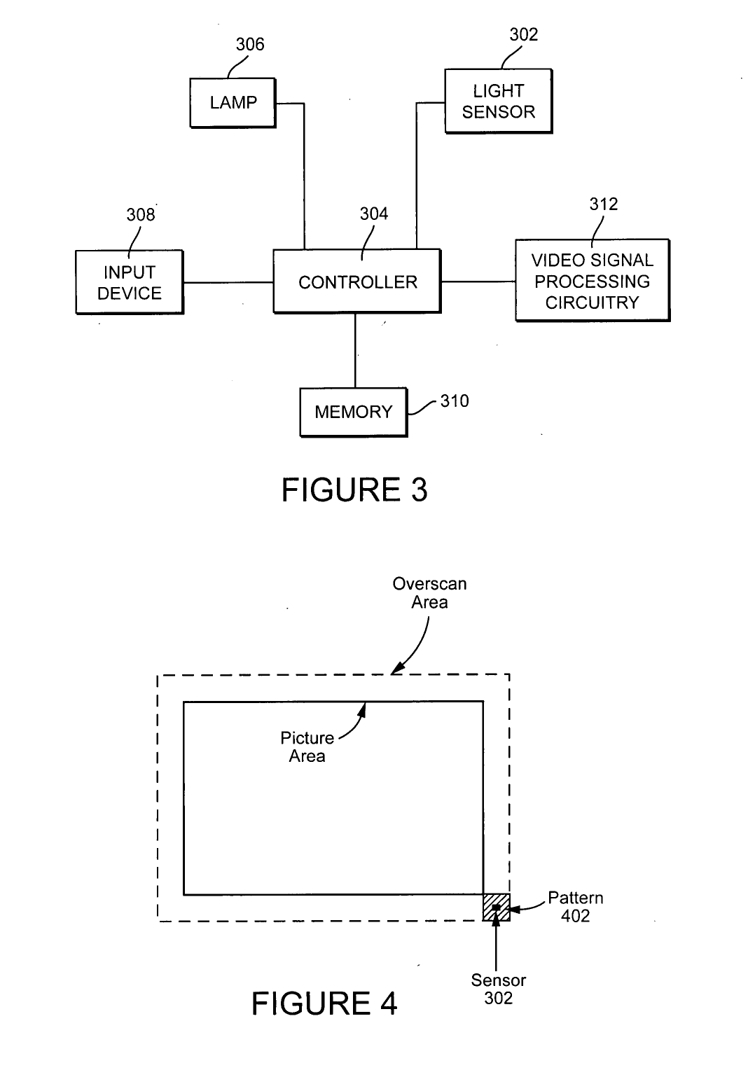

FIG. 3 is a block diagram showing an example arrangement of a brightness adjustment system. A light sensor 302 is electrically connected to a controller 304. Light sensor 302 may be of the analog or digital variety. If an analog sensor is used, an A/D converter (not shown) may be provided to convert the analog signals from this sensor to digital signals for supply to controller 304. As will be described in greater detail below, based on the brightness detected by light sensor 302, controller 304 controls the brightness level setting by, for example, making adjustments to change the level of light output by lamp 306. These adjustments are effected by, for example, changing the current or voltage supplied to the lamp 304. For some illumination devices (such as LEDs), the source may be modulated to change brightness. In another example implementation, brightness may be controlled, via video signal processing in which case controller 304 may control video signal processing circuitry 312 as shown in FIG. 3. Controller 304 also controls video processing circuitry 312 to add a pattern to the overscan area of a video signal as described in greater detail below

Generally speaking, to increase lamp brightness (and therefore picture brightness), the amount of current supplied to lamp 306 may be increased. By increasing the amount of current supplied to lamp 306, controller 304 can compensate for diminishing lamp output over time. More specifically, controller 304 can increase the amount of current so as maintain picture brightness at a user-desired brightness (e.g., as determined during an initialization procedure using an input device 308 such as a wireless remote control). In such an initialization procedure, the user can be prompted through the steps for setting the picture brightness level via displays of the user interface presented on screen 206.

Lamp brightness (and therefore picture brightness) can be decreased by decreasing the amount of current supplied to lamp 306. This decrease of current may be useful, for example, when a new lamp is installed. Because the new lamp will generally have much higher brightness than the lamp it replaced, controller 304 can decrease the current supplied to the lamp in order to maintain the picture brightness at the user-desired brightness.

When controller 304 can no longer compensate for the diminishing brightness it can prompt the user that the lamp needs to be replaced. Upon the user inputting via the user interface that the lamp has been replaced, the controller could automatically return to the new bulb voltage/current level to give the user the desired brightness.

A memory 310 stores program code for adjusting the brightness level setting as described herein. Memory 310 may be any type of memory including semiconductor memory, optical memory, magnetic memory or a combination of one or more of these. Memory 310 may also be a combination of on-board and removable memory. The program code may stored in memory 310 at the time of manufacture of the television, or the program code may be provided after manufacture via downloads from a cable or satellite television system. If the television is provided with USB, Firewire, 1394 or other inputs, the program code may be loaded into memory 310 from a computing device connected to the television via any of these inputs.

FIG. 4 shows an example position for light sensor 302. In this example implementation, light sensor 302 is positioned in an overscan portion of the picture. The overscan portion refers to the portion of the picture that is outside the physical viewing area of the television. Among other things, the overscan portion allows the picture to fill the viewing area without any edge or border showing. As shown in FIG. 4, light sensor 302 is positioned in the lower, right-side portion of the overscan area. However, the positioning of the light sensor is not limited in this respect.

By positioning the sensor in the overscan portion it does not interfere with the viewing of the picture. If the sensor is not in the overscan portion, the sensor could be mounted to a moving mechanical device that would move the sensor into the picture to measure brightness and then back out for viewing. If the sensor was placed between the lamp and an imager, the sensor would need not be in an overscan area. If the sensor were placed before the imager then it should be placed so that it does not block light from reaching the imager.

By positioning the sensor in an overscan area, the brightness effect of all components can be included in the measurement (e.g., illumination source, micro-display engine, mirrors, and lens). Alternatively, brightness could be measured on the illumination side of the engine before the light is focused on the imager.

In accordance with the brightness system described herein, a pattern 402 is added to the data for the overscan portion around the position of light sensor 302. The pattern may, for example, be generated by a pattern generator included in the video signal processing circuitry 312. By was of example without limitation, the pattern could be a solid color (or white) or some grid of colors. The pattern is preferably sized to cover the sensor, with some tolerance for optical alignment. The pattern ensures that the brightness is always measured on the same baseline and that the picture impinging on the sensor is not, for example, at a black or near-black level.

The pattern may be added to the picture at all times or only at certain times (e.g., times at which a light sensor measurement is to be taken). Because the overscan portion is not part of the physical viewing area, the addition of this pattern does not impact the quality of the displayed picture. Light sensor 302 will detect the brightness level of an area of the pattern 402 that illuminates the sensor.

The user may use input device 308 and the user interface to set a user-desired picture brightness. This picture brightness may be set to suit the user's taste. The adjustment of the picture brightness level may be displayed to the user in a manner similar to a progress meter: as the picture brightness level is increased, more bars of the meter are illuminated; as the picture brightness level is decreased, fewer bars of the meter are illuminated. Of course, other techniques may be used to provide visual feedback to the user and the brightness adjustment mechanism is not limited to any particular type of visual feedback. When the user has set a desired picture brightness level, light sensor 302 senses the brightness of an area of the pattern 304 that impinges thereon. The sensed brightness is supplied to controller 304 which then stores data indicative of this brightness in memory 310. This stored brightness will be used as a reference level to which later brightness measurements are compared.

The initial picture brightness may also be set to a default setting fixed at the time of manufacturing. In this case, during an initial use of the television, light sensor 302 senses the brightness of an area of the pattern 304 that impinges thereon. Controller 304 stores data indicative of this brightness in memory 310. In another implementation, data indicative of a default picture brightness may be stored in memory 310 at the time of manufacture.

The user will have an option to enable/disable the automatic brightness control mechanism. The mechanism may be enabled/disabled via inputs using input device 308 based on prompts provided by the user interface.

When the automatic brightness control feature is enabled, the television automatically checks the picture brightness by measuring the brightness detected by sensor 302 and making adjustments, if necessary. The automatic checking of brightness may occur at any or all of the following times. Preferably, measurements should be done after the lamp has reached full brightness (e.g., after lamp warm-up).
during a channel change
during volume changes
in response to pressing of a particular key sequence on a television control device (such as a remote control) for initiating an automatic check;
at periodic times which may be real times (e.g., every week) or operating time (e.g., after every 25 hours of television use). A memory location may store the time/date of the last measurement so it can be determined when the next measurement should take place; or
powering down of the television

Performing the measurement when a channel is changed may be desirable to reduce the possibility of the pattern affecting the picture displayed on the screen.

When the brightness is measured at one of these times, controller 304 compares the measured brightness to the reference brightness stored in memory 310. If the currently measured brightness is different than stored reference brightness, controller 304 automatically adjusts the setting of the picture brightness level so that the brightness detected by light sensor 302 matches the reference brightness. A look-up table or algorithm in the control program may be used to determine how much the current to the lamp should be changed in order to achieve the reference brightness level. Specifically, a table or algorithm may be referenced to determine that if the brightness has dropped “x” amount, the current should be adjusted by “y” amount. One or more brightness measurements may be taken after the lamp adjustment to confirm that the reference level has been achieved. The control program may also include some “hysteresis” to prevent the controller from changing the brightness for small sensor changes.

Data indicative of the new lamp brightness setting may be stored in memory 310 and can be displayed in response to user inputs via the input device 308. In this way, a user can monitor the brightness changes and even estimate how much time remains before a new lamp needs to be installed. The program code may include a routine (or routines) for automatically generating estimates of the remaining lamp life and make these estimates available to the user through the user interface.

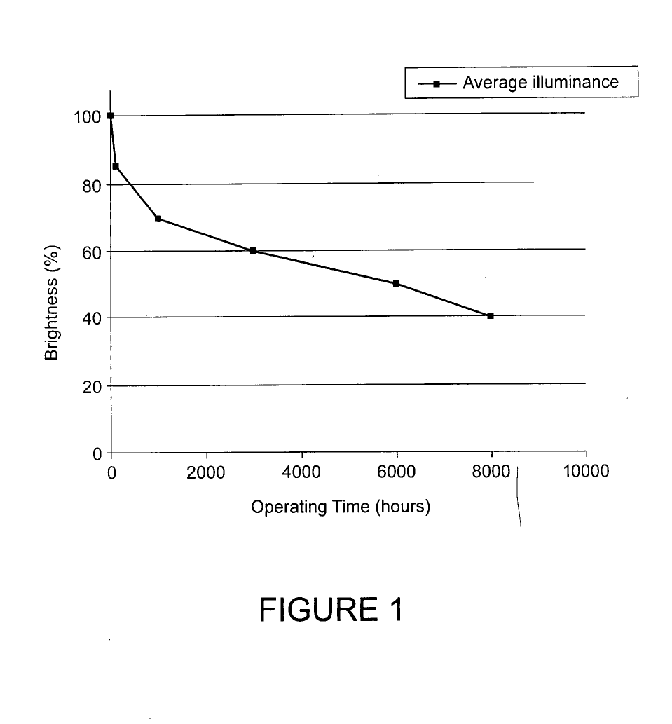

If a running record over time is maintained of the various brightness settings, the program code may be provided with graphics routines to generate graphs and charts like that shown in FIG. 1, for example. This record may be erased from memory 310 when a new lamp is installed or the old record could be maintained and a new record may be started. In the latter implementation, comparisons may be made between the brightness profiles over time of multiple lamps.

The system is also capable of downwardly adjusting the brightness setting. For example, when a new lamp is installed, it will typically have a much higher light output than the lamp it replaced. In order to compensate for this, the brightness may be automatically adjusted, after the lamp reaches peak output, so that the viewer's desired picture brightness is provided. This arrangement enables the user to avoid having to adjust the brightness after the installation of a new lamp.

Although the FIG. 4 implementation shows a single light sensor, the brightness adjusting mechanism may use two or more light sensors. These additional light sensors may include sensors positioned in the overscan region and/or in the picture area and/or between the lamp and the imager. In an implementation using two or more sensors, the brightness used by the controller 304 in the comparing may be a composite brightness derived from the brightnesses detected by the sensors. In one straightforward implementation, the composite level may be an average of the brightnesses detected by the sensors. In other implementations, different weights may be assigned to the measurements from the sensors in arriving at a composite level.

Brightness control may also be achieved by controlling a lamp in accordance with a preprogrammed function or look-up table that relates the amount of time the lamp has been in use to some specified lamp current (or voltage) value for that time. By way of example without limitation, the function may relate lamp operating time and lamp brightness. By way of further example without limitation, the look-up table may include lamp operating times and corresponding lamp brightness values. The function or look-up table may be developed based on lamp brightness versus operating time information (like that shown in FIG. 1) for a particular type of lamp. For example, a lamp brightness versus operating time function or look-up table for a particular lamp type (e.g., for a particular model from a particular manufacturer) may be developed by measuring brightness over time for multiple lamps of that particular type and then generating a characteristic function or look-up table for that lamp type as a composite of the data (e.g., obtained by an averaging process) for the multiple lamps. The functions or look-up tables for different lamp types may be stored in memory 310 either at the time of manufacture, via download over a communication network to which the television is connected, or via a USB, FireWire or other port provided on the television. The user can select via the user interface (e.g., from menus) the particular lamp type in the user's television and controller 304 will then automatically adjust the lamp brightness over time in accordance with the brightness versus operating time function or look-up table for the selected lamp. No sensors or detectors are needed to implement this control.

In one implementation, televisions may be programmed to store records of lamp brightness over time for the lamps used therein and then transmit these records (along with some identifier of the lamp type) to a centralized database (e.g., over the Internet or some other communication network to which the television is connected). This database can be used to develop the above-mentioned functions or look-up tables for particular types of lamps.

While there has been shown and described various embodiments of the present invention, it will be evident to those skilled in the art that various modifications may be made thereto without departing from the scope of the invention which is set forth in the appended claims.

I claim:

1. A television comprising:
a lamp;
video processing circuitry comprising a pattern generator for generating a pattern that is added to an overscan portion of a television picture signal;
a detector positioned in the overscan region of the television picture for detecting the added pattern and providing detection signals based on the detecting; and
a controller for controlling brightness of the lamp based on the detection signals.

2. The television according to claim 1, wherein the pattern is added to the television picture signal at all times.

3. The television according to claim 1, wherein the pattern is selectively added to the television picture signal.

4. The television according to claim 3, wherein the pattern is added to the television picture signal during a channel change.

5. The television according to claim 3, wherein the pattern is added to the television picture signal during a volume change.

6. The television according to claim 3, wherein the pattern is added to the television picture signal in response to a user input.

7. The television according to claim 3, wherein the pattern is added to the television picture signal at periodic real time intervals.

8. The television according to claim 3, wherein the pattern is added to the television picture signal at periodic operating time intervals.

9. The television according to claim 3, wherein the pattern is added to the television picture signal in response to a television power down signal.

10. The television according to claim 1, wherein the pattern is a sold color.

11. The television according to claim 1, wherein the pattern is a grid of different colors.

12. The television according to claim 1, wherein the pattern is sized to cover the detector.

13. The television according to claim 1, wherein the controller controls the brightness of the lamp to maintain a specified picture brightness.

14. The television according to claim 1, wherein the controller implements an algorithm to determine how much to change the brightness of the lamp based on the detection signals.

15. The television according to claim 1, wherein the controller uses a look-up table to determine how much to change the brightness of the lamp based on the detection signals.

16. The television according to claim 1, wherein the controller applies hysteresis to the controlling of the brightness of the lamp based on the detection signals.

17. The television according to claim 1, further comprising:
a memory for storing a record of brightness of the lamp over time.

18. The television according to claim 1, wherein the memory stores records of brightness over time for multiple lamps.

19. An automatic brightness adjustment system comprising:
a light sensor positioned in the overscan portion of a television display;
a control circuit for comparing a brightness sensed by the light sensor to a reference brightness and automatically adjusting the brightness of a lamp in response thereto.

20. The system according to claim 19, further comprising:
a memory for storing data indicative of the reference brightness.

21. The system according to claim 19, wherein the comparing is performed in response to a channel change.

22. The system according to claim 19, wherein the comparing is performed in response to a volume change.

23. The system according to claim 19, wherein the comparing is performed at periodic intervals.

24. A television incorporating the automatic brightness adjustment system of claim 19.

25. A method of adjusting brightness comprising:
sensing a brightness in the overscan portion of a television display;
comparing the sensed brightness to a reference brightness; and
adjusting the brightness of a lamp in response to the comparing.

26. A storage medium readable by a processing system and storing therein a computer program for adjusting a brightness by comparing a brightness sensed by a light sensor disposed in an overscan portion of a television display and adjusting the brightness of a lamp in response to the comparing.

27. A television comprising a storage medium according to claim 26.

28. A television comprising:
a lamp;
a memory storing characteristic data indicative of brightness changes over time for the lamp; and
a controller for controlling brightness of the lamp over time based on the characteristic data.

29. The television according to claim 28, wherein the characteristic data comprises a look-up table of lamp operating times and corresponding lamp brightness values.

30. The television according to claim 28, wherein the characteristic data comprises a function relating lamp operating time and lamp brightness.
